(19) United States
(12) Patent Application Publication
(10) Pub. No.: US 2026/0029833 A1
(43) Pub. Date: Jan. 29, 2026

(54) CART-TYPE COMMODITY REGISTRATION APPARATUS, INFORMATION PROCESSING DEVICE, AND INFORMATION PROCESSING METHOD

(71) Applicant: Toshiba Tec Kabushiki Kaisha, Tokyo (JP)

(72) Inventor: Wataru SAKURAI, Izu Shizuoka (JP)

(21) Appl. No.: 19/225,713

(22) Filed: Jun. 2, 2025

(30) Foreign Application Priority Data
Jul. 26, 2024 (JP) 2024-120998

(51) Int. Cl. G06F 1/3234; G06F 1/3231; G07G 1/00

(52) U.S. Cl. CPC G06F 1/3234; G06F 1/3231; G07G 1/0072; G07G 1/0081

(57) ABSTRACT

According to an embodiment cart-type commodity registration apparatus includes a cart, a battery, and a commodity registration device, such as a barcode scanner, that is on the cart and receives power from the battery. A movement sensor and an information processing terminal are also on the cart. The information processing terminal is configured to determine whether the cart is moving based on movement signals from the movement sensor indicating whether the cart is moving or stopped and control the commodity registration device to be in a reduced power mode when a received movement signal indicates the cart is moving above a threshold speed. The terminal can also be configured to place the commodity registration device in a sleep mode after a stopped signal has been continuously received from the movement sensor for a predetermined length of time.

### CROSS-REFERENCE TO RELATED APPLICATION

This application is based upon and claims the benefit of priority from Japanese Patent Application No. 2024-120998, filed Jul. 26, 2024, the entire contents of which are incorporated herein by reference.

### FIELD

Embodiments described herein relate generally to a cart-type commodity registration apparatus and an information processing device and an information processing method for such apparatuses.

### BACKGROUND

In a store such as a supermarket, a convenience store, or a volume retailer, a customer sometimes uses a cart-type commodity registration apparatus (sometimes referred to as a cart POS). In such cases, the customer usually gets the cart-type commodity registration apparatus from near the entrance of the store and then moves around the store while shopping.

A cart-type commodity registration apparatus may have mounted equipment, such as a tablet terminal, a measuring board, a product scanner, and a camera. The cart-type commodity registration apparatus thus needs a battery mounted thereon for electrically driving this various equipment.

Often such a cart-type commodity registration has a power saving function or mode, which may be necessary to prevent the battery from being exhausted during shopping by the customer. However, with incorporation of such power saving functions, the customer may not always be able to immediately use necessary equipment because of the power saving functions. As such, the user operability and user convenience of cart-mounted equipment is negatively affected.

### BRIEF DESCRIPTION OF THE DRAWINGS

FIG. 1 is an explanatory diagram illustrating a layout of a store.

FIG. 2 depicts a cart POS according to a first embodiment.

FIG. 3 depicts cart POSs on standby in a lined-up manner for charging.

FIG. 4 is a block diagram illustrating a hardware configuration of a cart POS.

FIG. 5 is a block diagram illustrating a hardware configuration of a measuring board.

FIG. 6 is a memory map illustrating a configuration of a flag information unit.

FIG. 7 is a block diagram illustrating a hardware configuration of a tablet terminal.

FIG. 8 is a block diagram illustrating a hardware configuration of a fixed scanner.

FIG. 9 is a sequence chart illustrating a flow of data transmission and reception among a measuring board, a tablet terminal, and a fixed scanner.

FIG. 10 depicts functional aspects of a measuring board and a tablet terminal.

FIG. 11 is a flowchart of control processing for a measuring board.

FIG. 12 is a flowchart of control processing for a tablet terminal.

FIG. 13 is a flowchart of control processing for a tablet terminal.

FIG. 14 is a flowchart of control processing for a fixed scanner.

FIG. 15 is a block diagram illustrating a hardware configuration of a cart POS according to a second embodiment.

FIG. 16 is a block diagram illustrating a hardware configuration of a tablet terminal according to a second embodiment.

FIG. 17 is a sequence chart illustrating a flow of data transmission and reception between a tablet terminal and a fixed scanner according to a second embodiment.

FIG. 18 depicts functional aspects of a tablet terminal in a second embodiment.

FIG. 19 is a flowchart of control processing for a tablet terminal in a second embodiment.

FIG. 20 is a flowchart of the control processing for a tablet terminal in a second embodiment.

### DETAILED DESCRIPTION

According to one embodiment, a cart-type commodity registration apparatus comprises a cart, a battery on the cart, a commodity registration device on the cart and receiving power from the battery, a movement sensor on the cart, and an information processing terminal. The information processing terminal is configured to determine whether the cart is moving based on movement signals from the movement sensor indicating whether the cart is moving or stopped. The terminal is also configured to control the commodity registration device to be in a reduced power mode when a received movement signal indicates the cart is moving above a threshold speed.

### First Embodiment

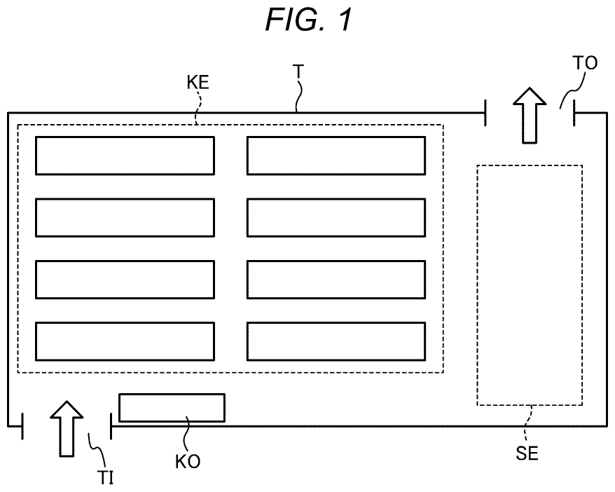

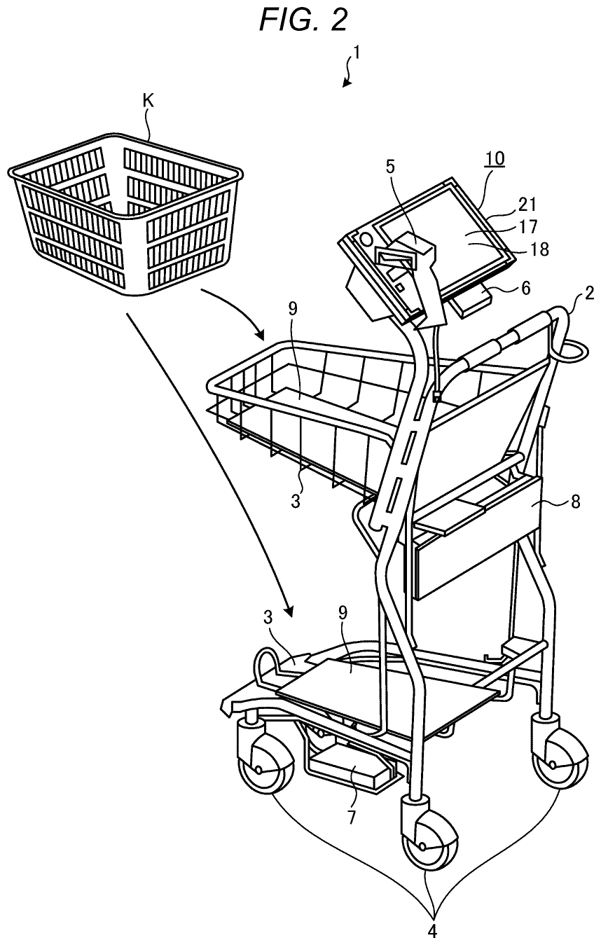

FIG. 1 is a diagram illustrating an example of a layout of a store T according to a first embodiment. The store T is a store selling commodities, such as a supermarket, a convenience store, a home improvement store, or a volume retail store. The store T includes an entrance TI, a shopping area KE, a settlement area SE, and an exit TO. In a cart storage KO near the entrance TI, cart POSs 1 (see FIG. 2) are placed in a lined-up manner. The cart POS 1 is a cart-type commodity registration apparatus. In this context, “POS” refers to a point-of-sale terminal or apparatus. The shopping area KE is an area where commodities to be sold to customers by the store T are displayed on shelves and the like. The settlement area SE is an area where POS terminals are installed and checkout such as settlement processing is performed for commodities to be purchased by customers. The exit TO is an exit for a customer having finished the checkout to exit the store T. Generally, a customer entering the store T from the entrance TI takes a cart POS 1 from the cart storage KO, walks (moves) around the shopping area KE, and picks up, from shelves, the commodities to be purchased and stores these selected commodities in the cart POS 1. Upon finishing picking up all commodities to be purchased, the customer moves to the settlement area SE, performs checkout for the commodities stored in the cart POS 1, then exits the store T via the exit TO together with the just purchased commodities. If the cart POS 1 itself has a checkout function, the customer may perform checkout processing at the cart POS 1 and exit the store T without stopping at the settlement area SE.

FIG. 2 is a perspective view illustrating the exterior of the cart POS 1 in the present embodiment. The cart POS 1 is used to carry commodities to be purchased. The cart POS 1 holds commodities to be purchased while the customer moves within the store T. A customer pushes and moves the cart POS 1 in the store T. The cart POS 1 includes a handle 2, a basket placing section 3, four casters 4, a touch scanner 5, a fixed scanner 6, a charging board 7, a battery 8, and a tablet terminal 10.

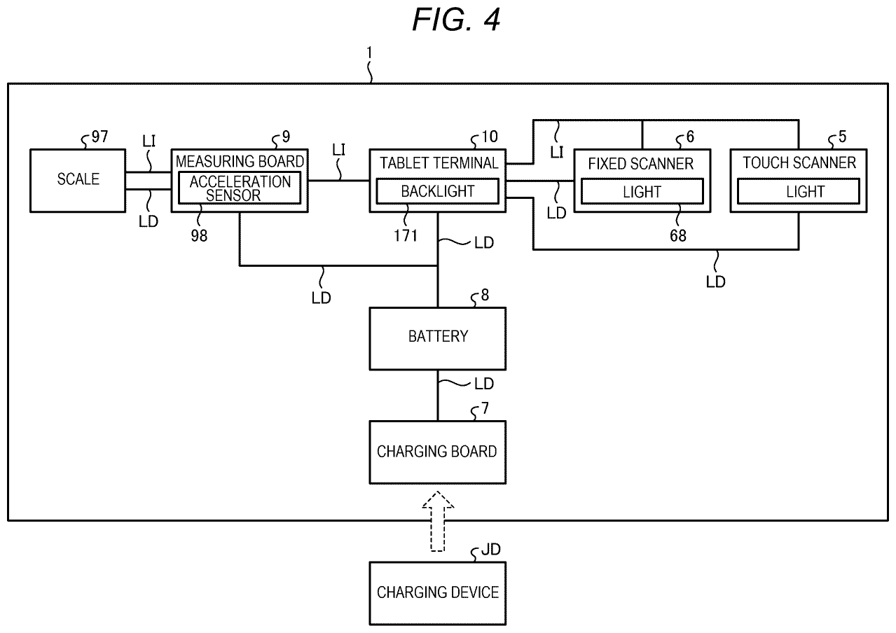

The handle 2 is a portion for a customer to grip to push and move the cart POS 1. The basket placing section 3 is a cart region in which a basket K can be placed. In the present embodiment, two basket placing sections 3 are provided, one in an upper portion and one in a lower portion of the cart POS 1. A scale 97 (see FIG. 4) for measuring the weight of the commodities stored in the basket K and a flat-shaped measuring board 9 that converts the measured weight into data and transmits the data to the tablet terminal 10 are placed on the bottom of the basket placing section 3. The basket K is placed on the scale 97 and the measuring board 9. If a commodity is stored in the basket K placed on the basket placing section 3, the scale 97 measures the weight of the commodity. The measuring board 9 transmits weight data indicating the weight of the commodity to the tablet terminal 10. The casters 4 are provided on the bottom of the cart POS 1. Since the respective casters 4 individually rotate, the cart POS 1 can be pushed by the customer and feely move in the store T.

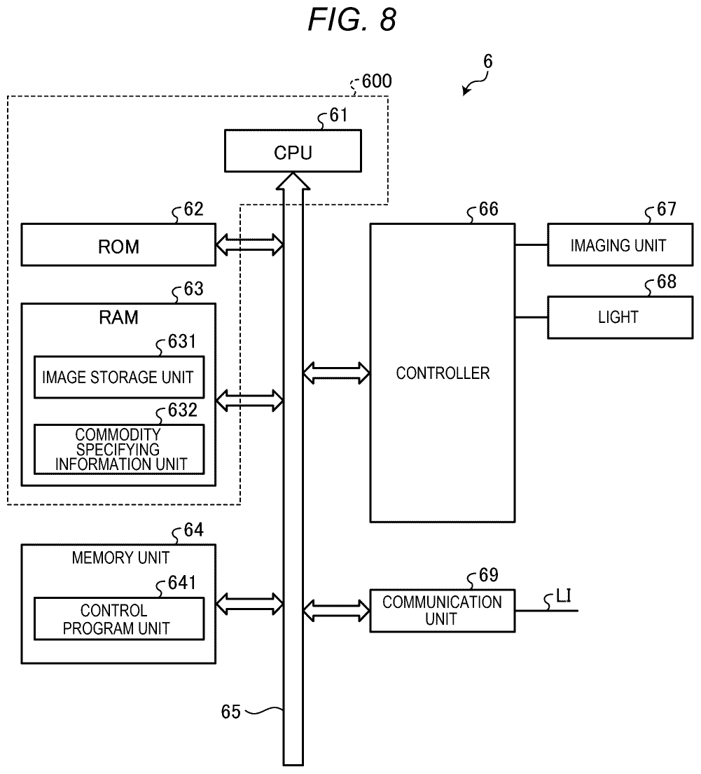

The touch scanner 5 and the fixed scanner 6 are devices that read a symbol, such as a barcode or other information for specifying the commodity), attached to a commodity to be purchased by the customer. The touch scanner 5 and the fixed scanner 6 include lights 68 (illustrated in FIG. 8) that emit light for reading symbols. The lights 68 may be referred to as scanning lights or scanner lights. The touch scanner 5 and the fixed scanner 6 irradiate the symbol with scanner light and an image sensor receives reflected light to read the symbol. In some examples, the touch scanner 5 and the fixed scanner 6 can optically read the symbol in an acquired image. The touch scanner 5 and the fixed scanner 6 transmit commodity specifying information (for example, a commodity code) obtained by decoding the symbol to the tablet terminal 10. The fixed scanner 6 is attached to the tablet terminal 10 in a fixed manner to face the basket K. The fixed scanner 6 can read a symbol of a commodity placed in the basket K. The touch scanner 5 is a hand-held or a handy-type scanner and can be detached from the tablet terminal 10 and the reattached after use. For example, touch scanner 5 can be detached from the tablet terminal 10 to read a symbol of a commodity stored in a basket K on the basket placing section 3 at the bottom of the cart POS 1.

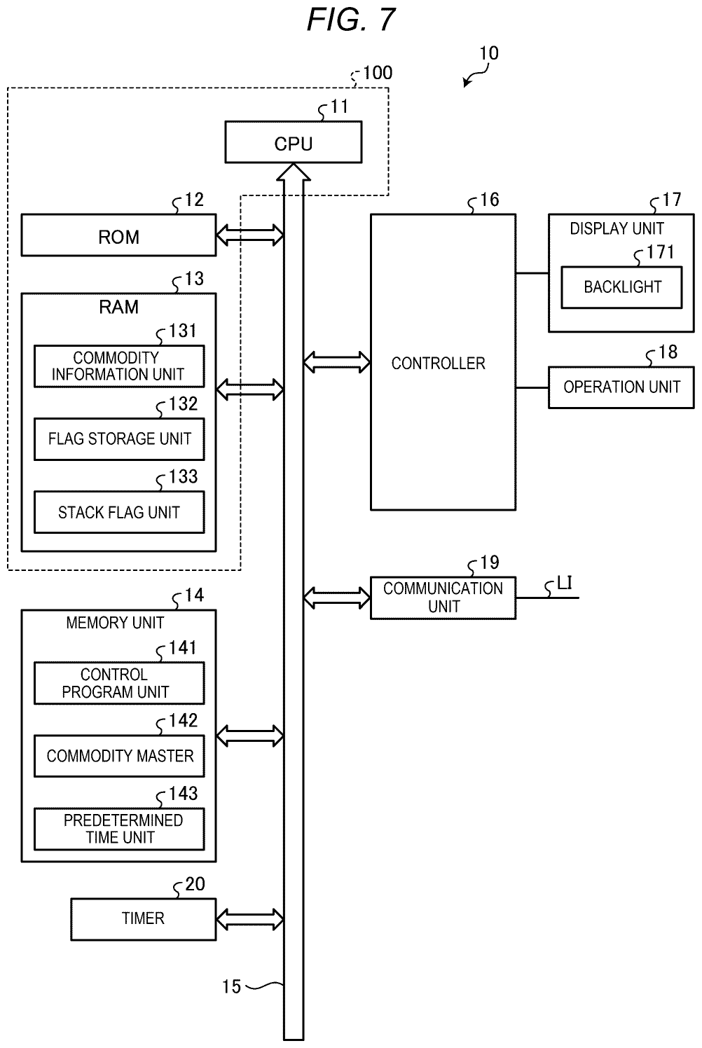

The tablet terminal 10 is an example of an information processing device. The tablet terminal 10 executes commodity registration processing f a commodity based on commodity specifying information acquired based on the symbol read by the scanner 6. In this context, touch scanner 5 or the fixed commodity registration processing refers to reading commodity information from a commodity master 142 (see FIG. 7) based on the acquired commodity specifying information, displaying the commodity information (such as a commodity name and a price) for the commodity on a display unit 17 (see FIG. 7), and storing (registering) the commodity information in a commodity information unit 131 (see FIG. 7).

The tablet terminal 10 has an appearance and functions like those of a so-called tablet computer and includes a display unit 17, an operation unit 18, and a backlight 171 (see FIG. 7) in a main body unit 21. In some examples, a separate camera may be attached to or integrated with the tablet terminal 10, the handle 2, or the like. The camera may be provided to monitor customer fraud or the like related to placement of a commodity in the basket K.

The display unit 17 is a display device such as a liquid crystal display. The display unit 17 displays information to the customer who operates the tablet terminal 10. The operation unit 18 is, for example, a touch input device (a touch panel) superimposed on the display surface of the display unit 17.

The battery 8 is attached in substantially the middle of the cart POS 1 (for example, right below the upper basket placing section 3). The battery 8 supplies electric power for driving the touch scanner 5, the fixed scanner 6, the scale 97, the measuring board 9, and the tablet terminal 10 and any other sub-units, equipment, or components of the cart POS 1. The battery 8 supplies electric power for the touch scanner 5 and the fixed scanner 6. If a camera is provided, the battery 8 supplied electric power to the camera. The battery 8 supplies electric power for driving the tablet terminal 10 and electric power for the backlight 171 (see FIG. 7). The battery 8 supplies electric power for the scale 97 to perform measurement. The battery 8 supplies electric power for driving the measuring board 9. The electric power may be directly supplied from the battery 8 to the touch scanner 5 and the fixed scanner 6 or may be supplied indirectly to such sub-units through the tablet terminal 10. Some equipment may be directly connected to the battery 8 or may be indirectly connected to the battery 8 through another component or device.

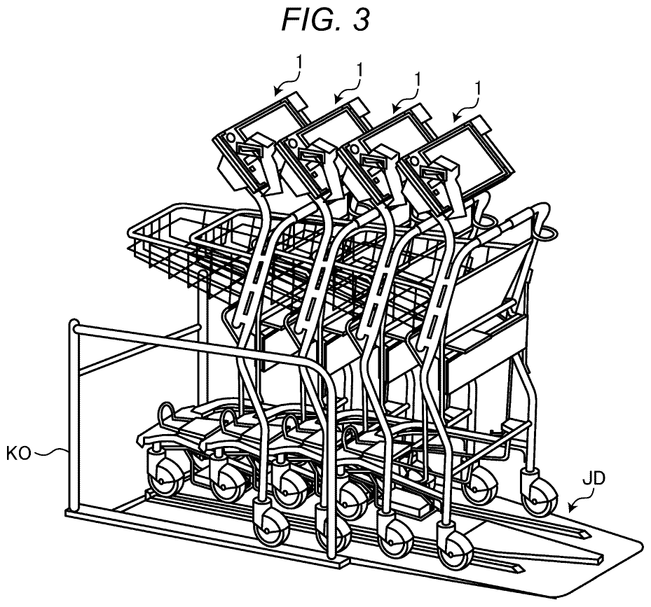

The charging board 7 is a power receiving unit for charging the battery 8 with power received from a charging device JD (see FIG. 3). The charging board 7 is attached below the lower basket placing section 3 of the cart POS 1.

Here, the charging of battery 8 from a charging device JD is explained. FIG. 3 is a diagram illustrating a state in which the cart POSs 1 are put on standby in a lined-up manner while being charged. The charging device JD is installed on the bottom surface section of the cart storage KO. When the cart POSs 1 are lined up in the cart storage KO, the charging boards 7 face the charging device JD at a predetermined distance from the charging device JD. In such a state, electric power may be supplied to the charging boards 7 from the charging device JD in a non-contact state, whereby the batteries 8 are charged inductively or the like. In FIG. 3, four cart POSs 1 are lined up. The batteries 8 respectively included in these four cart POSs 1 can be charged by the charging device JD at the same time.

FIG. 4 is a block diagram illustrating the hardware configuration of the cart POS 1. As illustrated in FIG. 4, the cart POS 1 includes a charging board 7, a battery 8, a tablet terminal 10, a measuring board 9, a scale 97, a fixed scanner 6, and a touch scanner 5.

Electric power can be supplied to the charging board 7 from the charging device JD. The charging board 7 is connected to the battery 8 by a feeder line LD and charges the battery 8 with the electric power supplied from the charging board 7 via the feeder line LD. The battery 8 is connected to the tablet terminal 10 and the measuring board 9 by another feeder line LD. Electric power is supplied to the tablet terminal 10 and the measuring board 9 from the battery 8 via this feeder line LD. The tablet terminal 10 and the measuring board 9 operate on the electric power supplied from the battery 8. The measuring board 9 is connected to the scale 97 by a feeder line LD and a signal line LI. The measuring board 9 supplies electric power to the scale 97 via the feeder line LD. The tablet terminal 10 and the measuring board 9 are connected by a signal line LI.

The tablet terminal 10 includes the backlight 171 and can be driven with the electric power supplied from the battery 8 and can light the backlight 171. In the following explanation, lighting the backlight 171 is sometimes referred to as “turn on” and extinguishing the backlight 171 is sometimes referred to as “turn off”.

The tablet terminal 10 is connected to the fixed scanner 6 and the touch scanner 5 by a feeder line LD and a signal line LI. The tablet terminal 10 supplies electric power to the fixed scanner 6 and the touch scanner 5 via the feeder line LD. The fixed scanner 6 includes a light 68 that can be driven with the electric power supplied from the tablet terminal 10. The tablet terminal 10 transmits a light-on command to the fixed scanner 6 and the touch scanner 5 via the signal line LI. The tablet terminal 10 transmits a light-off command to the fixed scanner 6 and the touch scanner 5 via the signal line LI.

The touch scanner 5 also includes a light. In general, the touch scanner 5 has the same basic configuration as the fixed scanner 6 as well as the same basic functions (including turning on and off an associated light).

The scale 97 measures the weight of a commodity using the electric power supplied from the measuring board 9. The scale 97 transmits measurement data indicating the measured weight to the measuring board 9 via the signal line LI.

The measuring board 9 receives the measurement data from the scale 97. The measuring board 9 transmits the received measurement data to the tablet terminal 10 via a signal line LI.

An acceleration sensor 98 (one example of a movement detection device) is mounted on the measuring board 9. The acceleration sensor 98 measures speed per unit time. The acceleration sensor 98 can be a solid-state device such as an integrated circuit (IC) device. The acceleration sensor 98 detects whether the measuring board 9 (the is, more generally, the cart POS 1) is presently moving or is stopped. The acceleration sensor 98 outputs signals at different levels (for example, different voltages) to indicate the movement state of the cart POS 1. Specifically, if the cart POS 1 is stopped, the acceleration sensor 98 outputs a signal at a level indicating that the cart POS 1 is stopped (a stop detection signal is output). If the cart POS 1 is moving, the acceleration sensor 98 outputs a signal at a level corresponding to the moving speed of the cart POS 1 (a movement detection signal is output). Accordingly, the measuring board 9 determines, based on the signal output level from the acceleration sensor 98, whether the cart POS 1 is stopped or is moving. The acceleration sensor 98 outputs a signal at a level corresponding to the speed of the cart POS 1. Output levels corresponding to particular speeds or threshold values may be stored in advance such that an output value from the acceleration sensor 98 can permit the measuring board 9 to determine whether the cart POS 1 is moving at a low speed (speed lower than some predetermined threshold speed) or at a high speed at or above the predetermined threshold speed.

For example, upon finishing the shopping and moving the cart POS 1 from the shopping area KE to the settlement area SE, the customer tends to move the cart POS 1 at high speed. While shopping in the shopping area KE, the customer tends to put commodities in the basket K while moving the cart POS 1 at lower speed. Accordingly, if a threshold is set for output values from the acceleration sensor 98, the measuring board 9 can determine, based on the output from the acceleration sensor 98, whether the moving speed of the cart POS 1 is a high speed or a low speed.

If the acceleration sensor 98 outputs a signal at a level indicating a stop of the cart POS 1, the measuring board 9 generates a “flag 2” as flag information indicating that the cart POS 1 is stopped. If the acceleration sensor 98 outputs a signal at a level indicating a moving of the cart POS 1 at a low speed, the measuring board 9 generates a “flag 1” as flag information indicating that the cart POS 1 is moving at the low speed. If the acceleration sensor 98 outputs a signal at a level indicating movement of the cart POS 1 at a high speed, the measuring board 9 generates a “flag 0” as flag information indicating that the cart POS 1 is moving at high speed. The measuring board 9 repeatedly transmits the generated flag information to the tablet terminal 10 at a fixed time interval (for example, one second).

Upon receiving a power-off command from the tablet terminal 10, the measuring board 9 turns off power.

The tablet terminal 10 receives the flag information from the measuring board 9. The tablet terminal 10 controls the fixed scanner 6 and the touch scanner 5 based on the received flag information. Specifically, if the cart POS 1 is moving at the high speed (flag 0), the tablet terminal 10 transmits a light off-command via a signal line L1 in order to turn off the lights 68 of the fixed scanner 6 and the touch scanner 5. When the cart POS 1 is moving at high speed, the fixed scanner 6 and the touch scanner 5 are generally not used to scan an item, so the lights 68 may be turned off. On the other hand, if the cart POS 1 is stopped (flag 2) or moving at low speed (flag 1), the tablet terminal 10 does not turn off the lights 68 of the fixed scanner 6 and the touch scanner 5 (keeps the lights 68 by not transmitting a light-off command). If the cart POS 1 is stopped or moving at low speed, the fixed scanner 6 and the touch scanner 5 might be used to scan an item, so the tablet terminal 10 keeps the lights 68 in a usable state (keeps the lights 68 on).

The tablet terminal 10 receives from the fixed scanner 6 or the touch scanner 5 the commodity specifying information acquired based on a symbol read in the scanning of an item (a commodity).

If the cart POS 1 is stopped continuously for some predetermined period (the flag 2 from the measuring board 9 is received continuously for a predetermined period), the tablet terminal 10 transmits the power-off command for turning off a power supply to the fixed scanner 6, the touch scanner 5, and the measuring board 9 via a signal line LI. If the cart POS 1 is stopped continuously for the predetermined period, the tablet terminal 10 can also turn off the backlight.

The fixed scanner 6 and the touch scanner 5 can read a symbol attached to a commodity when on. After receiving the light-off command from the tablet terminal 10, the fixed scanner 6 and the touch scanner 5 turn off the lights 68. After receiving a power-off command from the tablet terminal 10, the fixed scanner 6 and the touch scanner 5 turn off power supplies.

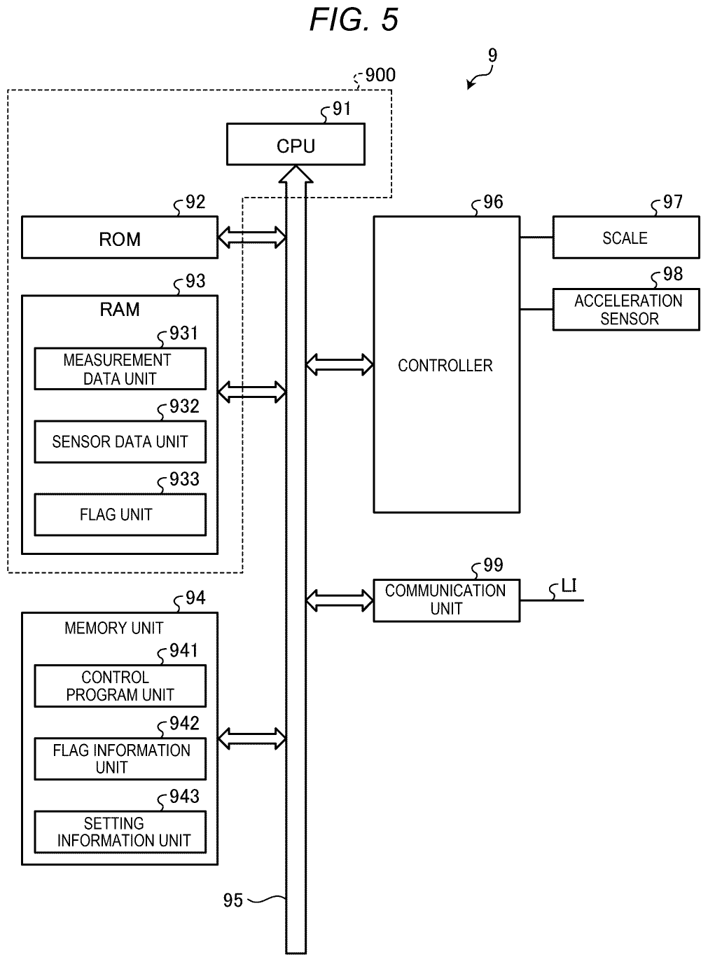

A hardware configuration of the measuring board 9 is explained below. FIG. 5 is a block diagram illustrating the hardware configuration of the measuring board 9. As illustrated in FIG. 5, the measuring board 9 includes a CPU (Central Processing Unit) 91 that is an example of a microprocessor, a ROM (Read Only Memory) 92, a RAM (Random Access Memory) 93, and a memory unit 94. The CPU 91 serves as a control entity of the measuring board 9. The ROM 92 stores various programs. Programs and various data are loaded in the RAM 93. The memory unit 94 stores various programs. The CPU 91, the ROM 92, the RAM 93, and the memory unit 94 are connected to one another via a bus 95. The CPU 91, the ROM 92, and the RAM 93 configure a control unit 900. That is, the CPU 91 operates according to a control program stored in the ROM 92 and the memory unit 94 and loaded in the RAM 93, whereby the control unit 900 executes control processing for the measuring board 9 as explained below.

The RAM 93 includes therein a measurement data unit 931, a sensor data unit 932, and a flag unit 933. The measurement data unit 931 stores measurement data (weight data) of weight measured by the scale 97. The sensor data unit 932 stores information concerning an output value (e.g., a value of output indicating whether the cart POS 1 is stopped, is moving at the low speed, or is moving at the high h speed) output by the acceleration sensor 98. The flag unit 933 searches through a flag information unit 942 based on the output value stored in the sensor data unit 932 and generates and stores flag information (the flag 0, the flag 1, or the flag 2) corresponding to the output value.

The memory unit 94 is a nonvolatile memory such as a HDD (Hard Disc Drive) or a flash memory. The memory unit 94 includes a control program unit 941, a flag information unit 942, and a setting information unit 943. The control program unit 941 stores a control program relating to the measurement board 9. The flag information unit 942 indicates a value of a signal output from the acceleration sensor 98 (for example, a voltage value corresponding to the speed of the cart POS 1 output by the acceleration sensor 98). The setting information unit 943 stores output from the acceleration sensor 98 serving as a threshold indicating a boundary between the movement at the low speed and the movement at the high speed of the cart POS 1. If the acceleration sensor 98 is outputting a signal (for example, a voltage) of a value smaller than the threshold, the cart POS 1 is considered to be moving at the low speed. If the acceleration sensor 98 is outputting a signal (for example, a voltage) of a value equal to or larger than the threshold, the cart POS 1 is considered to be moving at the high speed. If the output from the acceleration sensor 98 is a value smaller than the threshold, the measuring board 9 determines that the cart POS 1 is moving at the low speed. If the output from the acceleration sensor 98 is a value equal to or larger than the threshold, the measuring board 9 determines that the cart POS 1 is moving at the high speed. The threshold value stored in the setting information unit 943 can be changed. The specific speed to which the threshold value indicating the boundary between low speed and high speed is set is likely to affect convenience of use of the cart POS 1 by the customer. Therefore, the setting of the threshold stored in the setting information unit 943 may be changed according to a policy of the particular store T.

The control unit 900 is connected to the scale 97 and the acceleration sensor 98 via the bus 95 and a controller 96. The controller 96 receives an instruction from the control unit 900 and controls the scale 97 and the acceleration sensor 98. For convenience of explanation, the control performed by the controller 96 is explained as being performed by the control unit 900.

The scale 97 measures the weight of a commodity stored in the basket K and outputs measurement data. The acceleration sensor 98 outputs a signal indicating whether the cart POS 1 is stopped, is moving at the low speed, or is moving at the high speed.

The control unit 900 is connected to a communication unit 99 via the bus 95. The communication unit 99 is communicably connected to the tablet terminal 10 via the signal line LI. If receiving the power-off command from the tablet terminal 10 via the signal line LI, the control unit 900 stops the electric power supplied to at least the ROM 92, the RAM 93, the memory unit 94, the controller 96, and the scale 97 from the battery 8 via the feeder line LD. If receiving the power-on command from the tablet terminal 10 via the signal line LI, the control unit 900 supplies the electric power from the battery 8 to the ROM 92, the RAM 93, the memory unit 94, the controller 96, and the scale 97.

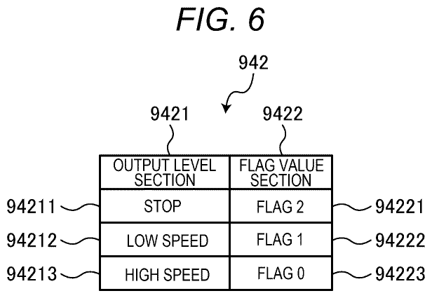

FIG. 6 is a memory map illustrating a configuration of the flag information unit 942. As illustrated in FIG. 6, the flag information unit 942 includes an output level section 9421 and a flag value section 9422. The output level section 9421 includes a stop area 94211, a low speed area 94212, and a high speed area 94213. The stop area 94211 stores an output value (the stop detection signal) of the acceleration sensor 98 in a state in which the cart POS 1 is stopped. A flag value area 94221 corresponding to the stop area 94211 stores the flag 2 that is the flag information indicating that the cart POS 1 is stopped. The low speed area 94212 stores an output value (the movement detection signal) of the acceleration sensor 98 in a range from output of the acceleration sensor 98 at the time when the cart POS 1 started movement in a stop state to output of the threshold stored in the setting information unit 943 (more accurately, the threshold is not included). If the acceleration sensor 98 performs the output in this range, the cart POS 1 is moving (traveling) at the low speed. A flag value area 94222 corresponding to the low speed area 94212 stores the flag 1 that is the flag information indicating that the cart POS 1 is moving at the low speed. The high speed area 94213 stores information (the movement detection signal) meaning an output value of the acceleration sensor 98 equal to or larger than the threshold. If the acceleration sensor 98 performs output equal to or larger than the threshold, the cart POS 1 traveling at high speed. A flag value area 94223 corresponding to the high speed area 94213 stores the flag 0, which is the flag information indicating that the cart POS 1 is moving at the high speed.

A hardware configuration of the tablet terminal 10 is explained below. FIG. 7 is a block diagram illustrating the hardware configuration of the tablet terminal 10. As illustrated in FIG. 7, the tablet terminal 10 includes a CPU 11 that is an example of a microprocessor, a ROM 12, a RAM 13, and a memory unit 14. The CPU 11 serves as a control entity of the tablet terminal 10. The ROM 12 stores various programs. Programs and various data are loaded in the RAM 13. The memory unit 14 stores various programs. The CPU 11, the ROM 12, the RAM 13, and the memory unit 14 are connected to one another via a bus 15. The CPU 11, the ROM 12, and the RAM 13 configure a control unit 100. That is, the CPU 11 operates according to a control program stored in the ROM 12 and the memory unit 14 and loaded in the RAM 13, whereby the control unit 100 executes control processing for the tablet terminal 10.

The RAM 13 includes a commodity information unit 131, a flag storage unit 132, and a stack flag unit 133. The commodity information unit 131 stores commodity information (commodity specifying information, a commodity name, a commodity price, and the like) of a commodity subjected to commodity registration processing. The flag storage unit 132 stores flag information (any one of the flag 0, the flag 1, and the flag 2) received from the measuring board 9. The flag storage unit 132 stores the latest flag information every time the flag information is received from the measuring board 9. The stack flag unit 133 stores a stack flag 1 if the cart POS 1 is stopped continuously for a predetermined time or more. The stack flag 1 is flag information indicating that the cart POS 1 is stopped continuously for the predetermined time or more. If the cart POS 1 is not stopped continuously for the predetermined time or more, the stack flag section 133 stores a stack flag 0. The stack flag 0 is flag information indicating that the cart POS 1 is not stopped continuously for the predetermined time or more.

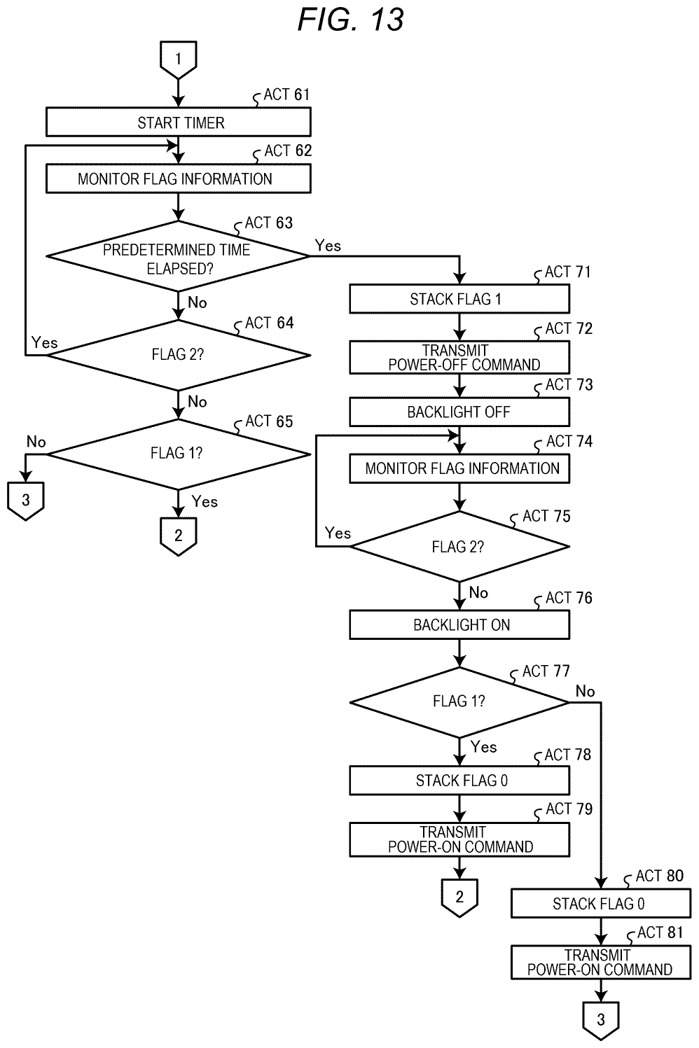

The memory unit 14 is a nonvolatile memory such as a HDD or a flash memory. The memory unit 14 includes a control program unit 141, a commodity master 142, and a predetermined time unit 143. The control program unit 141 stores a control program relating to the tablet terminal 10. The commodity master 142 stores commodity information about each of the commodities (items) sold in the store T. The commodity master 142 entries, for example are keyed to the commodity code for each commodity type. The predetermined time unit 143 stores the predetermined time value used in Act 63 in FIG. 13. The predetermined time in this context is the length of time for which the cart POS 1 is continuously stopped that is used for deciding that the cart POS 1 has been placed in the cart storage KO and will likely not be used for a while. The setting for the predetermined time value can be changed according to store preference or the like.

The control unit 100 is connected to the display unit 17 and the operation unit 18 via the bus 15 and a controller 16. The controller 16 receives an instruction from the control unit 100 and controls the display unit 17 and the operation unit 18. For convenience of explanation, the control performed by the controller 16 can be considered as being performed by or in cooperation with the control unit 100.

The display unit 17 is, for example, a liquid crystal display. The display unit 17 displays information to a customer who operates the tablet terminal 10 (that is, a customer who is pushing the cart POS 1). The display unit 17 includes the backlight 171 that lights up a display screen from the inside. The operation unit 18 is, for example, a touch panel provided on the display unit 17. The customer who operates the tablet terminal 10 operates the operation unit 18.

The control unit 100 is connected to a communication unit 19 via the bus 15. The communication unit 19 is communicably connected to the measuring board 9, the fixed scanner 6, and the touch scanner 5 via the signal line LI.

A hardware configuration of the fixed scanner 6 is explained. FIG. 8 is a block diagram illustrating the hardware configuration of the fixed scanner 6. As illustrated in FIG. 8, the fixed scanner 6 includes a CPU 61 that is an example of a microprocessor, a ROM 62, a RAM 63, and a memory unit 64. The CPU 61 serves as a control entity of the fixed scanner 6. The ROM 62 stores various programs. Programs and various data are loaded in the RAM 63. The memory unit 64 stores various programs. The CPU 61, the ROM 62, the RAM 63, and the memory unit 64 are connected to one another via a bus 65. The CPU 61, the ROM 62, and the RAM 63 configure a control unit 600. That is, the CPU 61 operates according to a control program stored in the ROM 62 and the memory unit 64 and loaded in the RAM 63, whereby the control unit 600 executes control processing for the fixed scanner 6.

The RAM 63 includes an image storage unit 631 and a commodity specifying information unit 632. The image storage unit 631 stores an image of a symbol attached to a commodity and captured (or read) by an imaging unit 67 (alternatively, an image of the commodity itself may be stored). The commodity specifying information unit 632 stores commodity specifying information for identifying the commodity, the commodity specifying information being acquired from the image of the symbol (or the commodity) stored in the image storage unit 631.

The memory unit 64 is a nonvolatile memory such as a HDD or a flash memory. The memory unit 64 includes a control program unit 641. The control program unit 641 stores a control program relating to the fixed scanner 6.

The control unit 600 connects the imaging unit 67 and the light 68 via the bus 65 and a controller 66. The controller 66 receives an instruction from the control unit 600 and controls the imaging unit 67 and the light 68. For convenience of explanation, the control performed by the controller 66 can be considered as being performed by or in cooperation with the control unit 600.

The imaging unit 67 is, for example, a camera and captures an image of a symbol attached to a commodity in the basket K (or the commodity itself). The light 68 emits light to the outside of the fixed scanner 6 and brightly lights up the commodity to be imaged more clearly or the like.

The control unit 600 is connected to a communication unit 69 via the bus 65. The communication unit 69 is communicably connected to the tablet terminal 10 via the signal line LI. If receiving the power-off command from the tablet terminal 10 via the signal line LI, the control unit 600 stops electric power supplied from the battery 8 to at least the ROM 62, the RAM 63, the memory unit 64, and the controller 66 via the feeder line LD. If receiving the power-on command from the tablet terminal 10 via the signal line LI, the control unit 600 supplies electric power from the battery 8 to the ROM 62, the RAM 63, the memory unit 64, and the controller 66.

A hardware configuration of the touch scanner 5 is substantially equivalent to the hardware configuration of the fixed scanner 6. Aspects or components that are the same or substantially so in the touch scanner 5 and the fixed scanner 6 may be provided the same reference symbols. In general, the touch scanner 5 has the same functions as the fixed scanner 6 and performs the same exchange with the tablet terminal 10 as the fixed scanner 6.

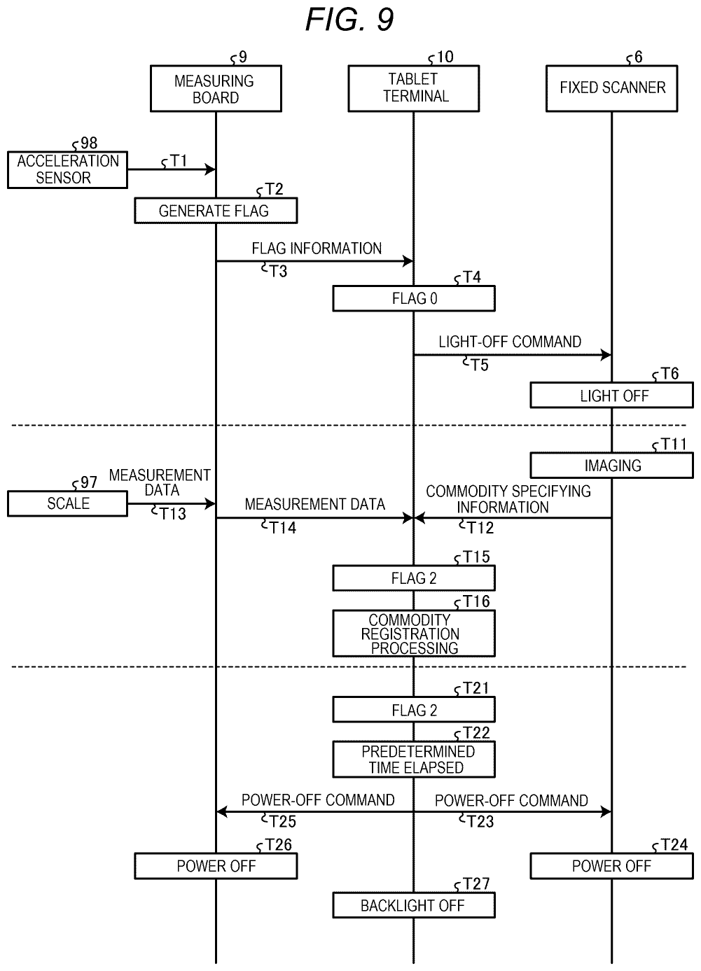

Exchange of data among the measuring board 9, the tablet terminal 10, and the fixed scanner 6 is explained. FIG. 9 is a sequence chart illustrating a flow of transmission and reception of data among the measuring board 9, the tablet terminal 10, and the fixed scanner 6. As illustrated in FIG. 9, the measuring board 9 receives an output value output by the acceleration sensor 98 (T1). The measuring board 9 refers to the flag information 942 and generates or sets flag information (the flag 0, the flag 1, or the flag 2) corresponding to the received output value (T2). The measuring board 9 transmits the generated flag information to the tablet terminal 10 (T3).

If the received flag information is the flag 0, the tablet terminal 10 determines that the cart POS 1 is moving at the high speed and transmits the light-off command to the fixed scanner 6 (T5). The fixed scanner 6 having received the light-off command turns off (extinguishes) the light 68 thereof.

In general, customer uses the fixed scanner 6 to read a symbol attached to a commodity being registered for purchased. The fixed scanner 6 reads the symbol from the commodity (T11). The fixed scanner 6 acquires, based on the read symbol, commodity specifying information and transmits the commodity specifying information to the tablet terminal 10 (T12). When the commodity is stored in the basket K, the measuring board 9 also receives measurement data corresponding to the commodity placed in the basket K from the scale 97 (T13). The measuring board 9 transmits this measurement data to the tablet terminal 10 (T14). The tablet terminal 10 checks whether the flag information received in T3 is the flag 2 (that is, whether the cart POS 1 is stopped) (T15) and, only if the flag information is the flag 2, executes commodity registration processing for the commodity using the commodity specifying information received in T12 and the measurement data (T16). In the case of a flag 0 or a flag 1 (that is, if the cart POS 1 is moving), the tablet terminal 10 does not execute the commodity registration processing for the item (that is, discards or ignores the measurement data, but may register an item based on the commodity specifying information received in T12 alone in some instances). When the cart POS 1 is moving, accurate measurement data is sometimes not obtained because of the influence of vibrations and the like associated with movement. Thus, only if the cart POS 1 is stopped will the tablet terminal 10 execute the commodity registration processing using the received measurement data. In the commodity registration processing, the tablet terminal 10 generally uses the measurement data for checking if the commodity stored in the basket K is actually the commodity specified by the received commodity specifying information.

If the cart POS 1 is stopped for a predetermined time or more (T21 and T22), the tablet terminal 10 transmits the power-off command to the fixed scanner 6 and the measuring board 9 (T23 and T25). The fixed scanner 6, having received a power-off command, turns off the power supply thereof (turns off the light as well) (T24). The measuring board 9, having received a power-off command, turns off the power supply thereof (T26). The tablet terminal 10 may turn off the backlight 171.

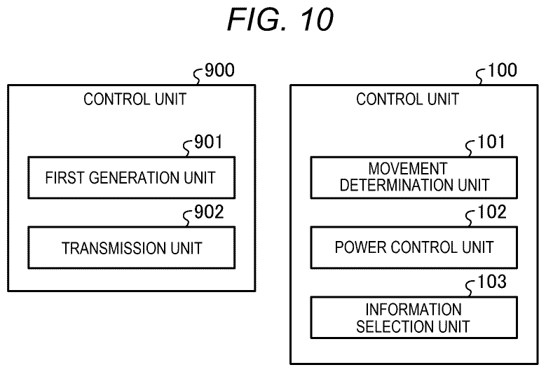

FIG. 10 is a functional block diagram illustrating the functional configurations of the measuring board 9 and the table terminal 10. The control unit 900 of the measuring board 9 functions as a first generation unit 901 and a transmission unit 902 according to the control program stored in the ROM 92 and the control program unit 941 of the memory unit 94.

The first generation unit 901 generates, based on the stop detection signal output by the acceleration sensor 98, the flag 2 that is the flag information indicating that the cart POS 1 is stopped, generates, based on the movement detection signal output by the acceleration sensor 98, the flag 1 that is the flag information indicating that the cart POS 1 is moving in the predetermined range of the low speed, and generates, based on the movement detection signal output by the acceleration sensor 98, the flag 0 that is the flag information indicating that the cart POS 1 is moving at a high speed. Specifically, the first generation unit 901 refers to the flag information unit 942 based on the stop detection signal output by the acceleration sensor 98 and generates the flag 2 indicating that the cart POS 1 is stopped, refers to the flag information unit 942 based on the movement detection signal output by the acceleration sensor 98 and generates the flag 1 indicating that the cart POS 1 is moving in the low speed range, and refers to the flag information unit 942 based on the movement detection signal output by the acceleration sensor 98 and generates the flag 0 indicating that the cart POS 1 is moving in the high speed range.

The transmission unit 902 transmits the generated flag information to the tablet terminal 10.

The control unit 100 of the tablet terminal 10 functions as a movement determination unit 101, a power control unit 102, and an information selection unit 103 according to the control program stored in the ROM 12 and the control program unit 141 of the memory unit 14.

The movement determination unit 101 determines the movement and the stop of the cart POS 1 based on the movement detection signal and the stop detection signal. In the first embodiment, the movement determination unit 101 determines the movement and the stop of the cart POS 1 based on the flag information generated by the measuring board 9 based on the movement detection signal and the stop detection signal. Specifically, the movement determination unit 101 determines the state of the cart POS 1 based on the flag 2, and the flag 0 received from the measuring board 9.

If the movement determination unit 101 determines the stop of the cart POS 1, the power control unit 102 controls the fixed scanner 6 to be driven with predetermined power consumption and, if the movement determination unit 101 determines the movement of the cart POS 1, the power control unit 102 controls the fixed scanner 6 to be driven with power consumption reduced from the predetermined power consumption. Specifically, if the movement determination unit 101 determines the movement of the cart POS 1, the power control unit 102 controls the light 68 of the fixed scanner 6 to be turned off. More specifically, if the movement determination unit 101 determines the movement of the cart POS 1, the power control unit 102 transmits the light-off command to the fixed scanner 6 to turn off the light 68 of the fixed scanner 6.

If the movement determination unit 101 determined the stop of the cart POS 1 continuously for a predetermined time or more, the power control unit 102 controls the power consumption of the fixed scanner 6 to be further reduced than the reduced power consumption and controls the power consumption of the tablet terminal 10 to be reduced to drive the tablet terminal 10. Specifically, if the movement determination unit 101 determined the stop of the cart POS 1 for the predetermined time or more, the power control unit 102 controls the power supply of the fixed scanner 6 to be turned off (the light to be turned off as well) and controls the backlight of the tablet terminal 10 to be turned off (extinguished). More specifically, if the movement determination unit 101 determined the stop of the cart POS 1 continuously for the predetermined time or more, the power control unit 102 transmits the power-off command to the fixed scanner 6 and controls the backlight of the tablet terminal 10 to be turned off (extinguished). If the movement determination unit 101 determined the stop of the cart POS 1 continuously for the predetermined time or more, the power control unit 102 transmits the power-off command to the measuring board 9 as well. The predetermined time is stored in the predetermined time unit 143 and can be optionally set and changed.

If receiving the flag 2 from the measuring board 9, the information selection unit 103 adopts weight data received from the measuring board 9 and, if receiving the flag 1 or the flag 0 from the measuring board 9, the information selection unit 103 ignores the weight data.

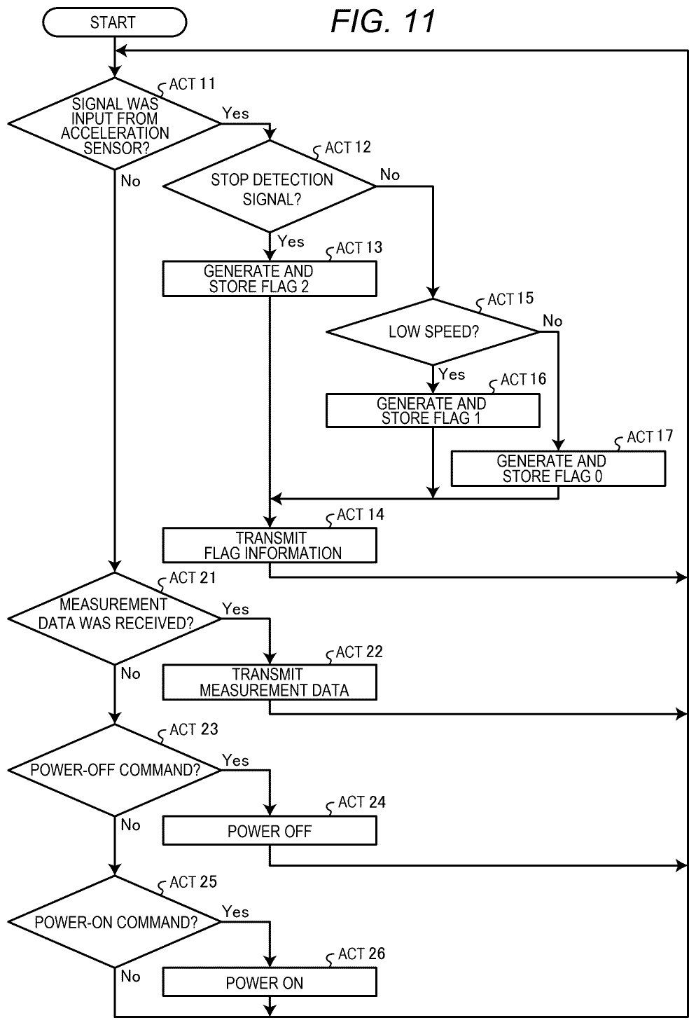

FIG. 11 is a flowchart illustrating a flow of control processing for the measuring board 9. As illustrated in FIG. 11, the control unit 900 of the measuring board 9 first determines whether a signal was input from the acceleration sensor 98 (Act 11). If so (Yes in Act 11), the control unit 900 stores the input output value in a sensor data unit 332 and next determines whether the stored output value is the stop detection signal stored in the stop area 94211 (Act 12). If the stored output value is the stop detection signal (Yes in Act 12), the first generation unit 901 generates the flag information (flag 2) indicating that the cart POS 1 is stopped and stores this flag information in flag unit 333 (Act 13). The transmission unit 902 transmits the flag information (the flag 2 value) stored in the flag unit 333 to the tablet terminal 10 (Act 14). The control unit 900 then returns to Act 11. Since the signal from the acceleration sensor 98 is input at fixed intervals (for example, one second), the processing in Act 11 to Act 17 may be executed every time the signal is input. For that reason, the transmission of the flag information to the tablet terminal 10 in Act 14 is performed at a frequency corresponding to the fixed interval.

If the stored output value is not the stop detection signal (No in Act 12), the control unit 900 next determines whether an output value is a movement detection signal included in the range for the output value stored in the low speed area 94212 (Act 15). If the output value is included in the low speed range of the output value (Yes in Act 15), the first generation unit 901 generates the flag information (the flag 1) indicating that the cart POS 1 is moving at low speed and stores this flag information in the flag unit 333 (Act 16). The transmission unit 902 then transmits the flag information (the flag 1 value) stored in the flag unit 333 to the tablet terminal 10 (Act 14). The control unit 900 next returns to Act 11. If the output value is not included in the low speed range for the output value (No in 15), the first generation unit 901 generates the flag information (the flag 0) indicating that the cart POS 1 is moving at high speed and stores this flag information in the flag unit 333 (Act 17). The transmission unit 902 transmits the flag information (the flag 0 value) stored in the flag unit 333 to the tablet terminal 10 (Act 14). The control unit 900 next returns to Act 11.

If a signal is not yet input (No in Act 11), the control unit 900 checks whether measurement data was received from the scale 97 (Act 21). If measurement data was received (Yes in Act 21), the control unit 900 transmits the received measurement data to the tablet terminal 10 (Act 22). The control unit 900 then returns to Act 11.

If measurement data was not received (No in Act 21), the control unit 900 checks whether a power-off command was received from the tablet terminal 10 (Act 23). If the power-off command was received (Yes in Act 23), the control unit 900 turns off the power supply of the measuring board 9 (Act 24). The control unit 900 then returns to Act 11.

If the power-off command was not received (No in Act 23), the control unit 900 next checks whether a power-on command was received from the tablet terminal 10 (Act 25). If the power-on command was received (Yes in Act 25), the control unit 900 turns on the power supply of the measuring board 9 (Act 26). The control unit 900 then returns to Act 11. If the power-on command was not received from the tablet terminal 10 (No in Act 25), the control unit 900 then returns to Act 11.

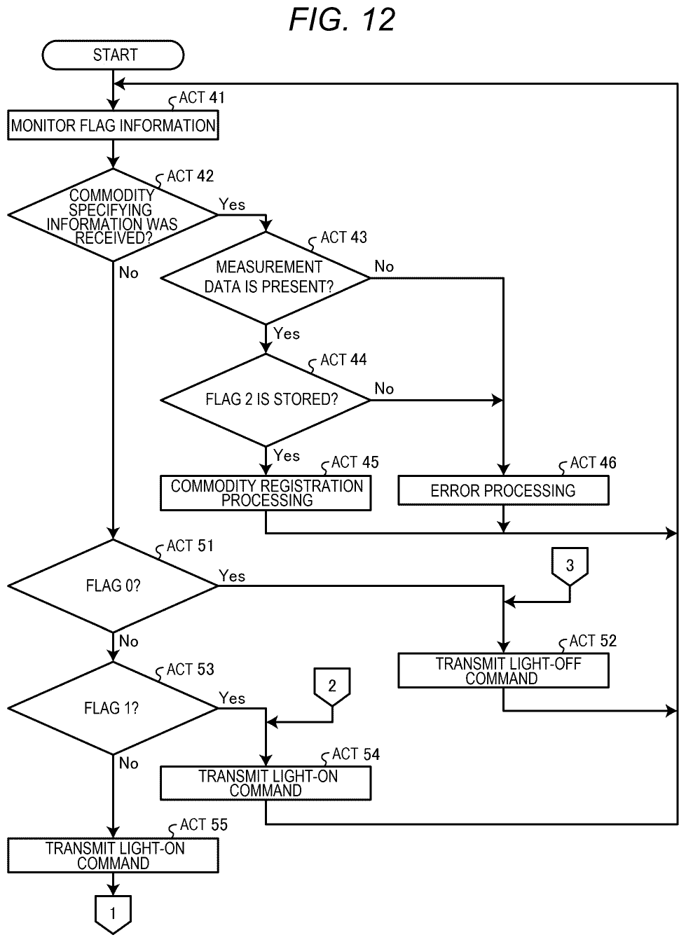

FIGS. 12 and 13 are flowcharts illustrating a flow of control processing for the tablet terminal 10. As illustrated in FIG. 12, the control unit 100 of the tablet terminal 10 stores the flag information received from the measuring board 9 in the flag storing section 132 and monitors the flag information (Act 41). In the processing in Act 41, every time the control unit 100 receives new flag information from the measuring board 9, the control unit 100 stores the newly received flag information in the flag storage unit 132.

Next, the control unit 100 checks whether commodity specifying information was received from the fixed scanner 6 (Act 42). If commodity specifying information was received (Yes in Act 42), the control unit 100 next determines whether measurement data was received from the measuring board 9 (Act 43). If measurement data was received (Yes in Act 43), the control unit 100 next checks whether the flag 2 is stored in a flag storage unit 432 (Act 44). If the flag 2 is stored (Yes in Act 44), the control unit 100 considers that the measurement data was generated while the cart POS 1 was stopped (and is thus measurement data having high reliability) and executes commodity registration processing relating to the commodity using the received commodity specifying information and the received measurement data (Act 45). The control unit 100 then returns to Act 41.

If the flag 2 is not stored in the flag storage unit 432 (that is, the flag 1 or the flag 0 is stored) (No in Act 44), the control unit 100 considers that the measurement data was generated while the cart POS 1 was moving (and is thus measurement data having low or lower reliability due to increased measurement noise due to vibrations and the associated with cart POS 1 movement) and executes error processing without executing commodity registration processing based the received measurement data (Act 46). The control unit 100 may read and discard this received measurement data. The control unit 100 next returns to Act 41.

If measurement data was not received from the measuring board 9 (No in Act 43), it is highly likely that measurement was not performed for a commodity even though a symbol was read by the fixed scanner 6, the control unit 100 executes error processing (Act 46) without executing commodity registration processing for a commodity identified by the received commodity specifying information. The control unit 100 then returns to Act 41.

If commodity specifying information was not received (No in Act 42), the control unit 100 checks whether the cart POS 1 is presently stopped or is moving. More particularly, the movement determination unit 101 checks whether the flag 0 is stored in the flag storage unit 132 (Act 51). If the flag 0 is stored (Yes in Act 51), the cart POS 1 is considered to be moving at the high speed, so the movement determination unit 101 transmits a light-off command to the fixed scanner 6 (or otherwise transmits a command for the fixed scanner 6 to be placed in a lower power consumption mode that is less than a normal power consumption mode) (Act 52). The control unit 100 then returns to Act 41.

If the flag 0 is not stored in the flag storage unit 132 (No in Act 51), the movement determination unit 101 next checks whether the flag 1 is stored in the flag storage unit 132 (Act 53). If the flag 1 is stored (Yes in Act 53), the cart POS 1 is considered to be moving at the low speed, so the movement determination unit 101 transmits the light-on command to the fixed scanner 6 (that is, transmits a command for the fixed scanner 6 to be placed in the normal power consumption mode) (Act 54). The control unit 100 then returns to Act 41.

If neither flag 1 and flag 0 is stored in the flag storage unit 132 (No in Act 53), the cart POS 1 is stopped (flag 2 is stored in the flag storage unit 132), the movement determination unit 101 transmits the light-on command to the fixed scanner 6 (that is, transmits a command for the fixed scanner 6 to be placed in a normal power consumption mode) (Act 55).

Referring now to FIG. 13, the control unit 100 starts a timer 20 (Act 61). The control unit 100 then monitors the flag information stored in the flag storage unit 132 (Act 62). The control unit 100 determines whether, according to the timer 20, a predetermined time matching the that stored in the predetermined time unit 143 has elapsed since the timer 20 started (Act 63). If not (No in Act 63), the control unit 100 checks whether the flag 2 is stored in the flag storage unit 132 (Act 64). If the flag 2 is stored (Yes in Act 64), the control unit 100 returns to Act 62, since the cart POS 1 is still stopped, and continuously monitors the flag information stored in the flag storage unit 132 and checks whether the predetermined time has elapsed yet.

If flag 2 is not stored in the flag storage unit 132 (No in Act 64), the control unit 100 checks whether the flag 1 is stored in the flag storage unit 132 (Act 65). If the flag 1 is stored (Yes in Act 65), the control unit 100 executes processing beginning in Act 54 since the cart POS 1 is now moving at the low speed. If the flag 1 is not stored (that is, the flag 0 is stored) (No in Act 65), the control unit 100 executes processing beginning in Act 52 since the cart POS 1 is now moving at the high speed.

If in Act 63 the predetermined time has elapsed (that is, the cart POS 1 has been stopped for the predetermined time or more) (Yes in Act 63), the control unit 100 sets the “stack flag” information stored in the stack flag unit 133 to the stack flag value “stack flag 1”) indicating that the cart POS 1 has not been used for a predetermined period (Act 71). The power control unit 102 transmits a power-off command to the measuring board 9 for reducing power consumption by the fixed scanner 6 and the like (Act 72). For example, power control unit 102 turns off the backlight 171 of the tablet terminal 10 (Act 73).

The unit 100 then monitors the flag control information in the flag storage unit 132 (Act 74) and checks whether the flag 2 is still stored (that is, the cart POS 1 has remained stopped) (Act 75). If the flag 2 is still stored (Yes in Act 75), the control unit 100 returns to Act 74 and continues to monitor the flag information. If a flag other than the flag 2 is now stored (No in Act 75), the control unit 100 turns on the backlight 171 of the tablet terminal 10 (Act 76).

The control unit 100 next checks whether the flag 1 is stored in the flag storage unit 132 (that is, whether the cart POS 1 is moving at the low speed) (Act 77). If the flag 1 is presently stored (Yes in Act 77), the control unit 100 stores the “stack flag 0” value in the stack flag unit 133 (Act 78). The control unit 100 then transmits the power-on command to the fixed scanner 6, the measuring board 9, and the like (Act 79). The control unit 100 then executes the processing in Act 54.

If the flag 1 is not stored in the flag storage unit 132 (that is, the flag 0 is stored) (No in Act 77), the control unit 100 stores the “stack flag 0” value in the stack flag unit 133 since the cart POS 1 is now moving at the high speed (Act 80). The control unit 100 now transmits the power-on command to the fixed scanner 6, the measuring board 9, and the like (Act 81). The control unit 100 then executes the processing in Act 52.

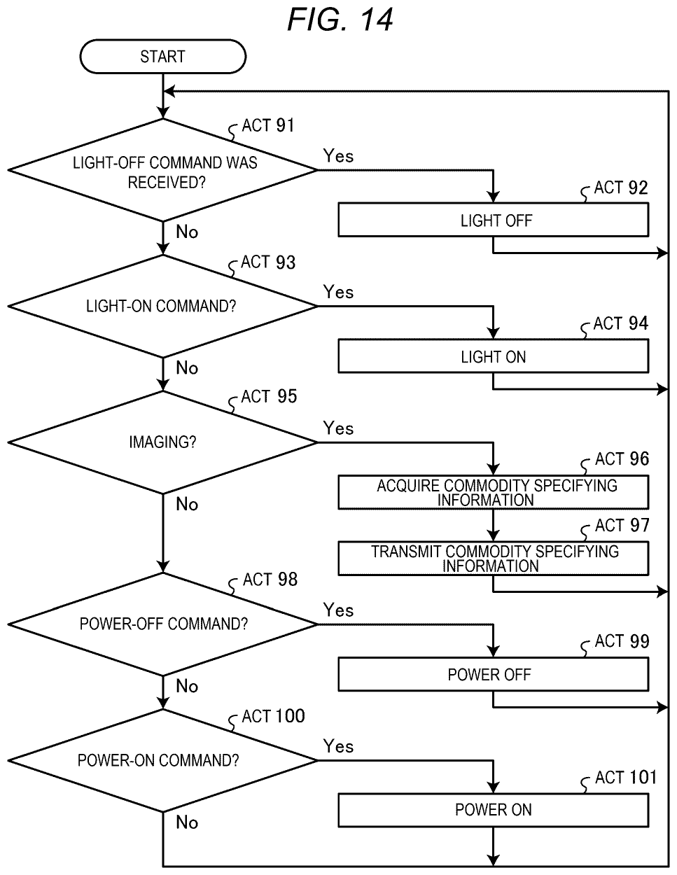

FIG. 14 is a flowchart illustrating a flow of control processing for the fixed scanner 6. As illustrated in FIG. 14, the control unit 600 of the fixed scanner 6 checks whether the light-off command has been received from the tablet terminal 10 (Act 91). If the light-off command was received (Yes in Act 91), the control unit 600 turns off (extinguishes) the light 68 (Act 92). The control unit 600 returns to Act 91.

If the light-off command was not received from the tablet terminal 10 (No in Act 91), the control unit 600 checks whether the light-on command was received from the tablet terminal 10 (Act 93). If the light-on command was received (Yes in Act 93), the control unit 600 turns on the light 68 (Act 94). The control unit 600 returns to Act 91.

If the power-on command was not received from the tablet terminal 10 (No in Act 93), the control unit 600 checks whether the imaging unit 67 has captured an image of a symbol attached to a commodity (or, alternatively, of the commodity itself when object recognition is being used) (Act 95). If the imaging unit 67 has captured an image of a symbol (or a commodity) (Yes in Act 95), the control unit 600 acquires, based on the captured image, commodity specifying information for identifying the commodity associated with the image (Act 96). The control unit 600 then transmits the acquired commodity specifying information to the tablet terminal 10 (Act 97).

If an image of a symbol (or a commodity) has not been captured (No in Act 95), the control unit 600 next checks whether the power-off command was received from the tablet terminal 10 (Act 98). If the power-off command was received (Yes in Act 98), the control unit 600 turns off the power supply to the fixed scanner 6 (and turns off the light as well) (Act 99). The control unit 600 then returns to Act 91.

If the power-off command was not received from the tablet terminal 10 (No in Act 98), the control unit 600 checks whether the power-on command was received from the tablet terminal 10 (Act 100). If the power-on command was received (Yes in Act 100), the control unit 600 turns on the power supply of the fixed scanner 6 (and turns on the light as well) (Act 101). The control unit 600 then returns to Act 91. If the power-on command was not received (No in Act 100), the control unit 600 returns to Act 91.

The touch scanner 5 can be controlled as illustrated in FIG. 14 in a manner similar to the fixed scanner 6.

As explained above, in the cart POS 1 in the first embodiment, the acceleration sensor 98 mounted on the measuring board 9 detects whether the cart POS 1 is moving or is stopped. If the cart POS 1 is stopped or if the cart POS 1 is moving at low speed, the tablet terminal 10 considers that the customer may be still purchasing items and turns on the light 68 of the fixed scanner 6 to permit registration. However, if the cart POS 1 is moving at high speed, the tablet terminal 10 considers that the customer is not presently attempting to purchase an item and turns off the light 68 of the fixed scanner 6 and also the touch scanner 5. With the cart POS 1 of this embodiment, since the light 68 of the fixed scanner 6 is on while the cart POS 1 is moving at a low speed, it is still possible for the customer to read a commodity symbol with the fixed scanner 6 even though the car POS 1 is moving at low speed. Thus, it possible to limit power consumption while still allowing the fixed scanner 6 mounted on the cart POS 1 to be operable by the customer for registration of items (commodities). This provides reduced power consumption and thus saves the power of the battery 8 without significantly limiting user convenience.

### Second Embodiment

A second embodiment is explained. A difference in the second embodiment compared with the first embodiment is that the cart POS 1 in the second embodiment does not include a scale 97 and a measuring board 9. The acceleration sensor 98 in the second embodiment is mounted in the tablet terminal 10 or the like. For that reason, the tablet terminal 10 itself generates the flag 0, the flag 1, and the flag 2 based on output of the acceleration sensor 98. Measurement data is not used when commodity registration processing is performed. For that reason, whenever the commodity registration processing is being performed, it is not necessary to determine whether cart POS 1 is stopped. In general, the other components and aspects are the same as in the first embodiment. In the following explanation of the second embodiment, those components and aspects that are the same, or substantially so, as the components and aspects in the first embodiment will be denoted by the same reference symbols to simplify explanation.

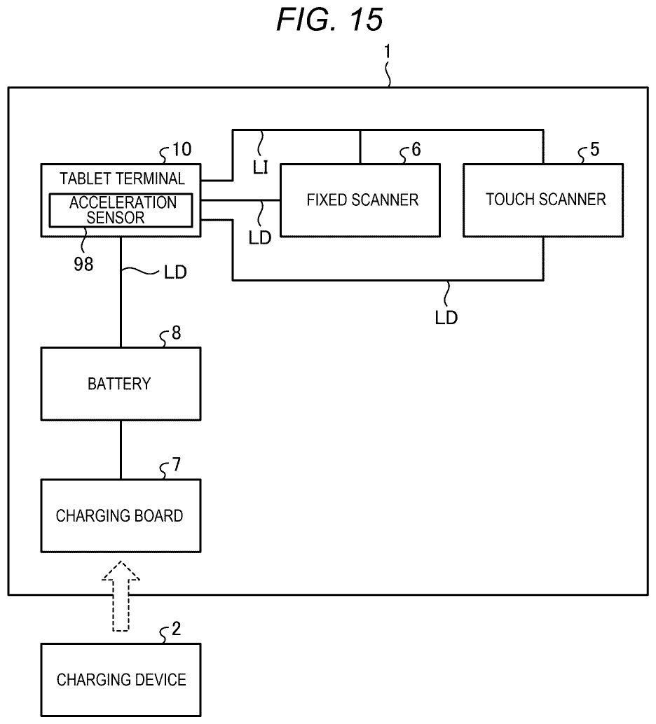

FIG. 15 is a block diagram illustrating a hardware configuration of the cart POS 1 according to the second embodiment. As illustrated in FIG. 15, the cart POS 1 in the second embodiment includes a charging board 7, a battery 8, a tablet terminal 10, a fixed scanner 6, and a touch scanner 5 but does not include the scale 97 and the measuring board 9 found in the first embodiment. The tablet terminal 10 incorporates the acceleration sensor 98 or is integrated therewith.

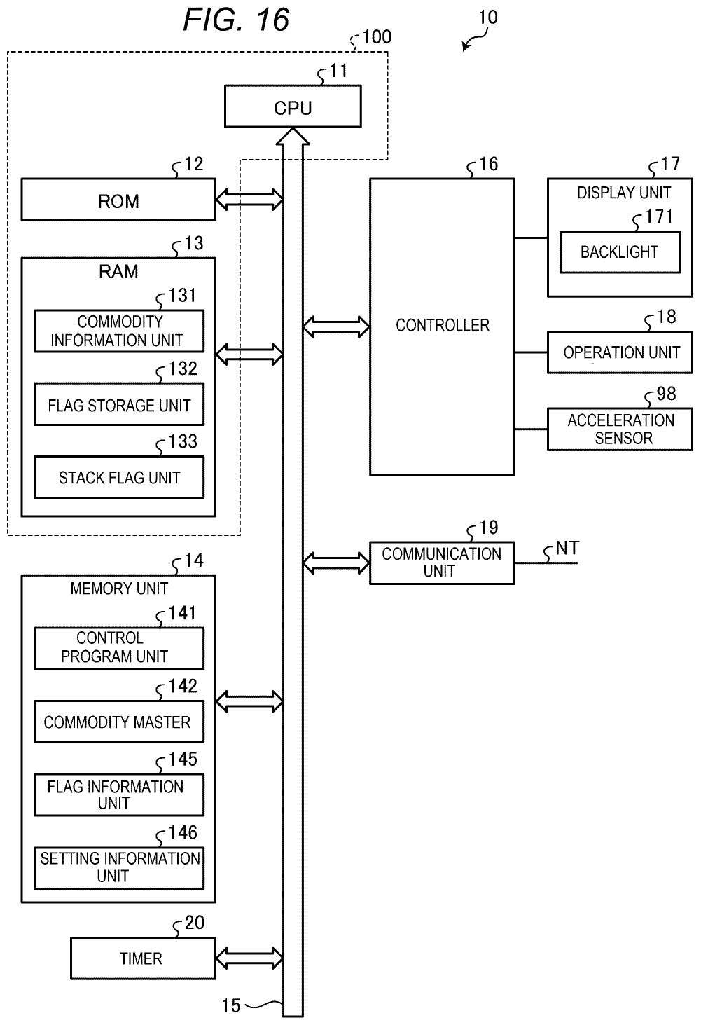

FIG. 16 is a block diagram illustrating a hardware configuration of the tablet terminal 10 according to the second embodiment. In FIG. 16, the memory unit 14 includes a flag information unit 145 and a setting information unit 146. The flag information unit 145 has the same configuration as the flag information unit 942 in the first embodiment. In the setting information unit 146, the predetermined time value and the threshold value of the first embodiment are stored. The setting information can be changed according to need or preference. In this context, predetermined time, as in the first embodiment, is the length time considered in Act 63 in FIG. 13. Similarly, the threshold value means, as in the first embodiment, an output value from the acceleration sensor 98 that is a boundary line indicating whether the cart POS 1 is moving at the low speed or the high speed. The acceleration sensor 98 is connected to the controller 16. Components equivalent to the sensor data unit 332 and the flag unit 333 (see FIG. 5) are included in the tablet terminal 10 (e.g., in the RAM 13) in the second embodiment.

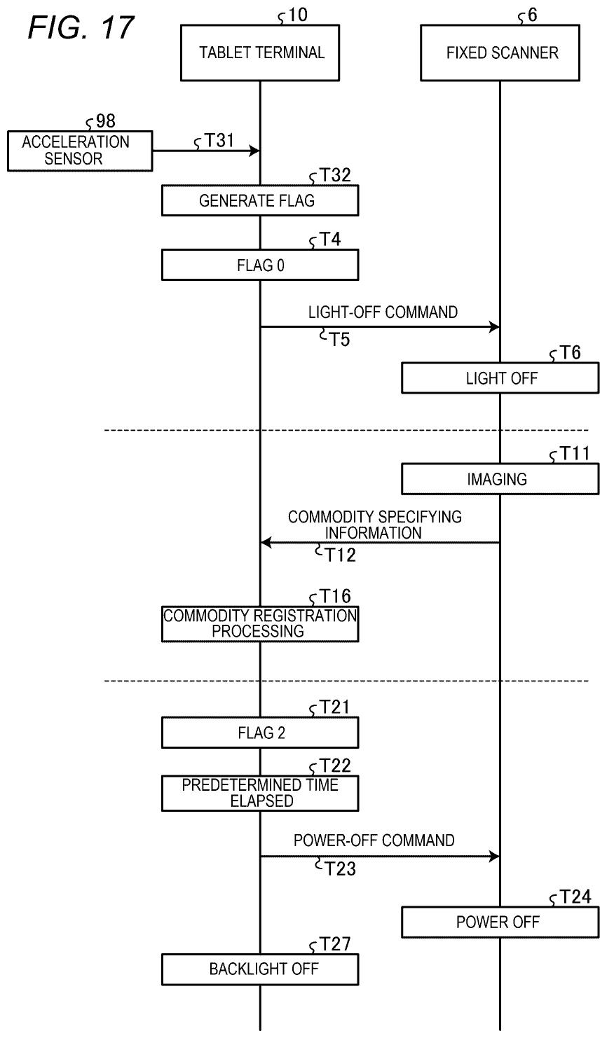

FIG. 17 is a sequence chart illustrating a flow of transmission and reception of data between the tablet terminal 10 and the fixed scanner 6 in the second embodiment. As illustrated in FIG. 17, the tablet terminal 10 receives a signal from the acceleration sensor 98 (T31). The tablet terminal 10 refers to the flag information unit 145 and generates the flag information (the flag 0, the flag 1, and the flag 2) based on the signal value (T32).

Upon receiving commodity specifying information from the fixed scanner 6, the tablet terminal 10 executes commodity registration processing based on the commodity specifying information. Unlike in FIG. 9 for the first embodiment, the tablet terminal 10 does not use measurement data and thus does not determine whether flag information is flag 2 (whether the cart POS 1 is stopped) a precondition for executing the commodity registration processing.

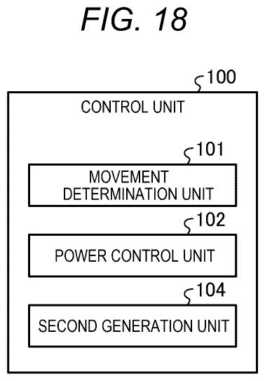

FIG. 18 is a functional block diagram illustrating a functional configuration of the tablet terminal 10 in the second embodiment. The control unit 100 of the tablet terminal 10 functions as the movement determination unit 101, the power control unit 102, and a second generation unit 104 according to a control program stored in the ROM 12 and/or a control program unit 141 of the memory unit 14.

The second generation unit 104 refers to the flag information unit 145 set based on output of the acceleration sensor 98. The second generation unit 104 sets the flag value to flag 2, corresponding to a stop detection signal and indicating that the cart POS 1 is stopped, to the flag 1) corresponding to a movement detection signal and indicating that the cart POS 1 is moving at a low speed, and to flag 0) corresponding to a movement detection signal and indicating that the cart POS 1 is moving at a high speed.

The movement determination unit 101 identifies whether the cart POS 1 is moving or stopped based on the movement detection signal and/or the stop detection signal. In the second embodiment, the movement determination unit 101 identifies whether the cart POS 1 is moving or stopped based on flag information generated by the tablet terminal 10. A threshold between whether the cart POS 1 is moving at low speed or high speed is stored in the setting information unit 146 and may be set or changed to any value.

If the movement determination unit 101 determines cart POS 1 has stopped, the power control unit 102 controls the fixed scanner 6 to use normal (full operating) power consumption. If the movement determination unit 101 determines the cart POS 1 is moving, the power control unit 102 controls the fixed scanner 6 to be driven with reduced power consumption (less than full operating power consumption). For example, if the movement determination unit 101 determines the cart POS 1 is moving, the power control unit 102 controls the light 68 of the fixed scanner 6 to be turned off (extinguished).

If the movement determination unit 101 determined the cart POS 1 has been stopped continuously for some predetermined time or more, the power control unit 102 controls the power consumption of the fixed scanner 6 to be reduced to a standby or idle state to and the power consumption of the tablet terminal 10 can also be reduced. For example, if the movement determination unit 101 determines the cart POS 1 has been stopped continuously for a predetermined time, the power control unit 102 controls the power supply of the fixed scanner 6 to be turned off (the light to be turned off as well) and controls the backlight of the tablet terminal 10 to be turned off (extinguished). The length of this predetermined time is stored in the setting information unit 146 and can be set or changed according to operator preferences.

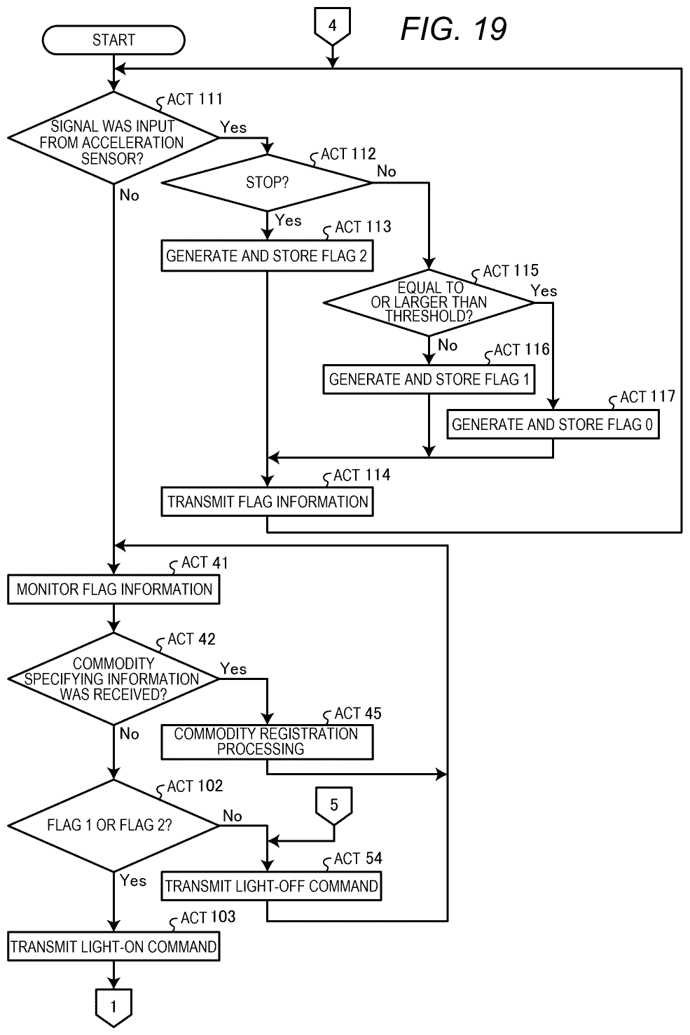

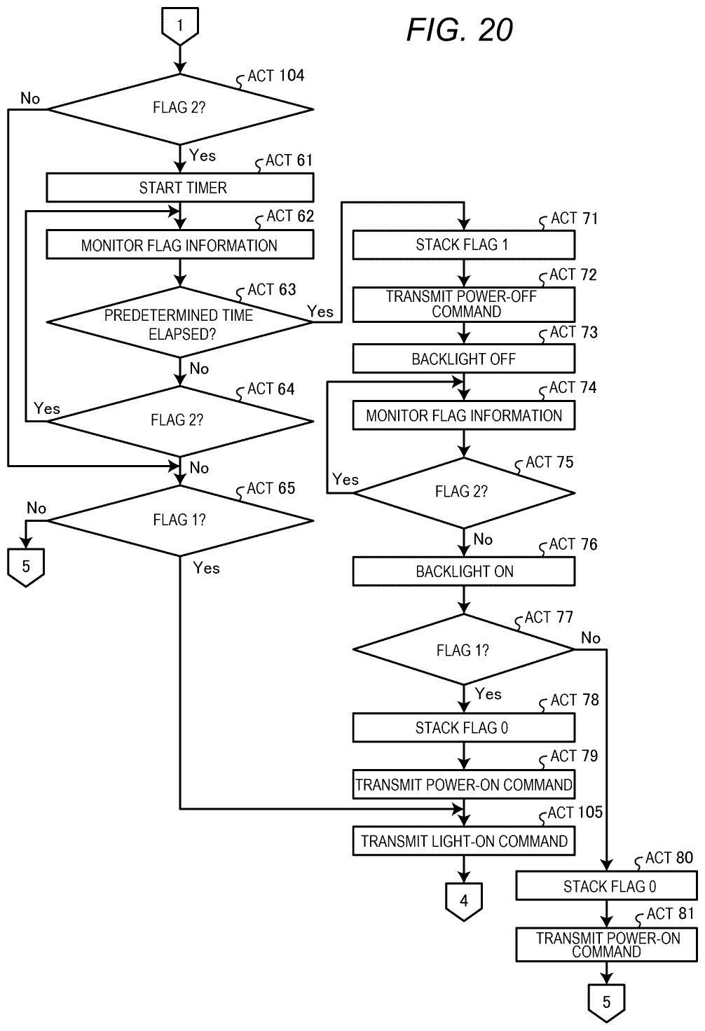

FIGS. 19 and 20 are flowcharts illustrating a flow of control processing for the tablet terminal 10 according to the second embodiment. As illustrated in FIG. 19, the control unit 100 executes processing in Act 111 to Act 117. The processing in Act 111 to Act 117 is generally equivalent to the corresponding processing described for Act 11 to Act 17 in FIG. 11 unless otherwise noted. The second generation unit 104 generates the flag 2 in Act 113, generates the flag 1 in Act 116, and generates the flag 0 in Act 117.

When commodity specifying information from the fixed scanner 6 is received (Yes in Act 42), the control unit 100 in this second embodiment does not execute the described processing associated with Act 43, Act 44, and Act 46 in FIG. 12 but does execute the processing in Act 45. If commodity specifying information was not received (No in Act 42), the movement determination unit 101 checks whether either flag 1 or the flag 2 is stored in the flag storage unit 132 (Act 102). If one of the flag 1 or the flag 2 is stored, the control unit 100 transmits the light-on command to the fixed scanner 6 (Act 103). If the flag 0 is stored (No in Act 102), the control unit 100 executes the processing in Act 54.

After the processing in Act 103, picking up description in FIG. 20, the control unit 100 checks whether the flag 2 is stored in the flag storage unit 132 (Act 104). If the flag 2 is stored (Yes in Act 104), since the cart POS 1 is currently stopped, the control unit 100 executes the processing in Act 61 and the relevant subsequent acts (e.g., the determination as whether the cart POS 1 has been stopped continuously for the predetermined time or more). If the flag 2 is not stored (No in Act 104), the cart POS 1 is moving and the control unit 100 next executes the determination in Act 65.

For a Yes in Act 77 after setting of “stack flag 1” (e.g., switch to standby or idle power mode), since the cart POS 1 is moving at low speed, the processing in Act 78 and Act 79 is executed, and then the control unit 100 transmits the light-on command to the fixed scanner 6 (Act 105). The control unit 100 then returns to Act 111. For a No in Act 77, since the cart POS 1 is moving at high speed, the processing in Act 80 and Act 81 is executed, and the control unit 100 returns to Act 54. For a Yes in Act 65, since the cart POS 1 is moving at the low speed, the control unit 100 executes the processing in Act 105. For a No in Act 65, since the cart POS 1 is moving at the high speed, the control unit 100 executes the processing in Act 54.

As explained above, in the cart POS 1 in the second embodiment, the acceleration sensor 98 mounted on the tablet terminal 10 detects whether the cart POS 1 is moving or is stopped. If the cart POS 1 is stopped and if the cart POS 1 is moving at the low speed, the tablet terminal 10 considers that a commodity may be being purchased by a customer and turns on the lights 68 of the fixed scanner 6 and the touch scanner 5. If the cart POS 1 is moving at the high speed, the tablet terminal 10 considers that a commodity is presently not being purchased by the customer and turns off the lights 68 of the fixed scanner 6 and the touch scanner 5. With the cart POS 1 of the second embodiment, when the cart POS 1 is moving at the low speed, the lights 68 of the fixed scanner 6 and the touch scanner 5 are turned on. Therefore, it is possible to maintain the operability of the fixed scanner 6 and the touch scanner 5 mounted on the cart POS 1 but still save the power of the battery 8 in other instances.

The cart POS 1 has a battery 8 from which power is supplied to operate various equipment (e.g., the fixed scanner 6 and the touch scanner 5) as well as the tablet terminal 10. A cart POS 1 including an acceleration sensor 98 that outputs the movement detection signal indicating whether the cart POS 1 is moving or the stop detection signal indicating that the cart POS 1 is stopped permits the various sub-units (e.g., equipment and/or tablet terminal) of the cart POS 1 to be turned off or placed in reduced power consumption modes as appropriate to the current movement state and the like. The tablet terminal 10 in the second embodiment includes the movement determination unit 101 that identifies the movement and the stop of the cart POS 1 based on a movement detection signal and a stop detection signal. The table terminal 10 also includes power control unit 102 that controls the power levels supplied to, or the operating states of the equipment, and the like on the cart POS 1 for reduced power consumption and battery life when appropriate in view of customer/user operability.

In some examples, an acceleration sensor 98 is used as a movement detection device. However, in other examples, the movement detection device may be of some other type, for example, a gyro sensor or a motion sensor.

In an embodiment, the power control unit 102 of the tablet terminal 10 is configured to transmit the light-off command to the fixed scanner 6 and the touch scanner 5, and the fixed scanner 6 and the touch scanner 5 are configured to receive the light-off command and turn off the lights 68 by themselves. However, in other examples, the tablet terminal 10 may be configured to block (or switch off) electric power for lighting supplied to the fixed scanner 6 and the touch scanner 5 to force a turn off of the lights 68 of the fixed scanner 6 and the touch scanner 5. In an embodiment, power control unit 102 may be configured to transmit the power-off command to the fixed scanner 6, the touch scanner 5, and the measuring board 9, and the fixed scanner 6, the touch scanner 5, and the measuring board 9 receive the power-off command and turn off the power supplies by themselves. However, in other examples, the tablet terminal 10 may be configured to block (or switch off) electric power for to the fixed scanner 6, the touch scanner 5, and the measuring board 9 to force a turn off of the fixed scanner 6, the touch scanner 5, and the measuring board 9.

In an embodiment, the fixed scanner 6 and the touch scanner 5 are used as examples of equipment incorporated in the cart POS 1. However, equipment incorporated in the cart POS 1 is not particularly limited in any way. For example, the equipment in this context may additionally or instead include a camera for fraud monitoring. The camera may have different operating modes with different power consumption levels. For example, the camera may include a light that is attached to the cart POS 1 that may be turned on/off, or a light or lamp may be included in the equipment of the cart POS 1 separately from the camera.

Note that a program to be executed by the tablet terminal 10 may be provided by being recorded in a non-transitory, computer-readable recording medium such as a CD-ROM, a flexible disk (FD), a CD-R, or a DVD (Digital Versatile Disk) as a file of an installable format or an executable format.

A program to be executed by the tablet terminal 10 in embodiments may be stored in a computer connected to a network such as the Internet and provided by being downloaded through the network. The program to be executed by the tablet terminal 10 may be provided or distributed through a network such as the Internet. A program to be executed by the tablet terminal 10 may be configured to be incorporated in a ROM Or the like in advance.

While certain embodiments have been described, these embodiments have been presented by way of example only, and are not intended to limit the scope of the present disclosure. Indeed, the novel embodiments described herein may be embodied in a variety of forms; other furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A cart-type commodity registration apparatus, comprising:
a cart;
a battery on the cart;
a commodity registration device on the cart and receiving power from the battery;
a movement sensor on the cart; and
an information processing terminal configured to:
determine whether the cart is moving based on movement signals from the movement sensor indicating whether the cart is moving or stopped; and
control the commodity registration device to be in a reduced power mode when a received movement signal indicates the cart is moving above a threshold speed.

2. The cart-type commodity registration apparatus according to claim 1, wherein the information processing terminal is further configured to:
place the commodity registration device in a sleep mode having a power consumption level lower than the reduced power mode after a stopped signal has been continuously received from the movement sensor for a predetermined period of time.

3. The cart-type commodity registration apparatus according to claim 2, further comprising:
a display screen integrated with or connected to the information processing terminal, wherein
the information processing terminal is further configured to:
turn off the display screen after the stopped signal has been continuously received for the predetermined period of time.

4. The cart-type commodity registration apparatus according to claim 1, further comprising:
a measuring board on the cart and configured to transmit weight data to the information processing terminal, the weight data indicating a weight of a commodity placed in or on the cart, the weight data generated by a scale on the cart.

5. The cart-type commodity registration apparatus according to claim 4, wherein the movement sensor is mounted on the measuring board.

6. The cart-type commodity registration apparatus according to claim 5, wherein the measuring board is configured to:
transmit, based on a detection of the movement sensor, a first flag signal indicating that the cart is stopped to the information processing terminal;
transmit, based on a detection of the movement sensor, a second flag signal indicating that the cart is moving at a speed below the threshold speed to the information processing terminal; and
transmit, based on a detection of the movement sensor, a third flag signal indicating that the cart is moving at a speed above the threshold speed to the information processing terminal.

7. The cart-type commodity registration apparatus according to claim 6, wherein the information processing device further includes an information selection unit configured to adopt the received weight data if the first flag signal is received and not to adopt the received weight data if the second flag signal or the third flag signal is received.

8. The cart-type commodity registration apparatus according to claim 4, wherein the information processing terminal further includes an information selection unit configured to use the received weight data if the first flag is received and not to use the received weight data if the second flag or the third flag is received.

9. The cart-type commodity registration apparatus according to claim 1, wherein the movement sensor is in the information processing terminal.

10. The cart-type commodity registration apparatus according to claim 9, wherein the information processing terminal is configured to:
set, based on a detection of the movement sensor, a first flag indicating that the cart is stopped;
set, based on a detection of the movement sensor, a second flag indicating that the cart is moving at a speed below the threshold speed; and
set, based on a detection of the movement sensor, a third flag indicating that the cart is moving at a speed above the threshold speed.

11. The cart-type commodity registration apparatus according to claim 10, further comprising:
a scale on the cart to provide weight data to the information processing terminal, wherein
the information processing device further includes an information selection unit configured to use the received weight data if the first flag is set and not to use the received weight data if the second flag or the third flag is set.

12. The cart-type commodity registration apparatus according to claim 1, wherein
the commodity registration device is a barcode scanner, and
a scanning light of the commodity registration device is turned off in the reduced power mode.

13. The cart-type commodity registration apparatus according to claim 12, wherein the barcode scanner is a hand-held barcode scanner.

14. An information processing terminal for a cart-type commodity registration apparatus, the information processing terminal comprising:
a display unit;
a storage unit;
a communication unit connected to a commodity registration device; and
a processor configured to:
determine whether a cart on which the information processing terminal is mounted is moving based on movement signals from a movement sensor on the cart, the movement signals indicating whether the cart is moving or stopped; and
control the commodity registration device to be in a reduced power mode when a received movement signal indicates the cart is moving above a threshold speed.

15. The information processing terminal according to claim 14, wherein the processor is further configured to:
place the commodity registration device in a sleep mode having a power consumption level lower than the reduced power mode after a stopped signal has been continuously received from the movement sensor for a predetermined period of time.

16. The information processing terminal according to claim 15, wherein the processor is further configured to:
turn off a backlight of the display unit after the stopped signal has been continuously received for the predetermined period of time.

17. The information processing terminal according to claim 16, wherein the processor is further configured to:
register an item in a sales transaction based on a commodity code received via the communication unit from the commodity registration device.

18. An information processing method for a cart-type commodity registration apparatus, the information processing method comprising:
determining whether the cart-type commodity registration apparatus is moving based on movement signals from a movement sensor of the cart-type commodity registration apparatus, the movement signals indicating whether the cart-type commodity registration apparatus is moving or stopped; and
controlling a commodity registration device of the cart-type commodity registration apparatus to be in a reduced power mode when a received movement signal indicates the cart-type commodity registration apparatus is moving above a threshold speed.

19. The information processing method according to claim 18, further comprising:
placing the commodity registration device in a sleep mode having a power consumption level lower than the reduced power mode after a stopped signal has been continuously received from the movement sensor for a predetermined period of time.

20. The information processing method according to claim 18, further comprising:
setting, based on a detection of the movement sensor, a first flag indicating that the cart-type commodity registration apparatus is stopped;
setting, based on a detection of the movement sensor, a second flag indicating that the cart-type commodity registration apparatus is moving at a speed below the threshold speed; and
setting, based on a detection of the movement sensor, a third flag indicating that the cart-type commodity registration apparatus is moving at a speed above the threshold speed.
